(19) United States
(12) Patent Application Publication
(10) Pub. No.: US 2025/0309307 A1
(43) Pub. Date: Oct. 2, 2025

(54) REGENERATIVE FUEL CELL SYSTEM AND METHOD OF OPERATING THE SAME

(71) Applicant: HONDA MOTOR CO., LTD., TOKYO (JP)

(72) Inventors: Satoshi INOUE, WAKO-SHI (JP); Koki TAMURA, WAKO-SHI (JP)

(21) Appl. No.: 19/061,426

(22) Filed: Feb. 24, 2025

(30) Foreign Application Priority Data
Mar. 27, 2024 (JP) 2024-052150

(51) Int. Cl. H01M 8/18; H01M 8/04082; H01M 8/04089; H01M 8/04119; H01M 8/04492; H01M 8/04746

(52) U.S. Cl. CPC H01M 8/186; H01M 8/04097; H01M 8/04164; H01M 8/04201; H01M 8/045; H01M 8/04507; H01M 8/04514; H01M 8/04776

(57) ABSTRACT

A regenerative fuel cell system includes a water electrolysis device, a hydrogen compression device, and a fuel cell. The regenerative fuel cell system further includes external relief valves including a first one between an oxygen supply path for supplying oxygen gas from the water electrolysis device to the fuel cell and a vacuum space, a second one between a second hydrogen supply path for supplying hydrogen gas from the hydrogen compression device to the fuel cell and a vacuum space, a third one between a hydrogen discharge path through which hydrogen gas not pressurized in the hydrogen compression device flows and a vacuum space, and a fourth one between a first hydrogen supply path through which hydrogen gas supplied from the water electrolysis device to the hydrogen compression device flows and a vacuum space.

### CROSS-REFERENCE TO RELATED APPLICATIONS

This application is based upon and claims the benefit of priority from Japanese Patent Application No. 2024-052150 filed on Mar. 27, 2024, the contents of which are incorporated herein by reference.

### BACKGROUND OF THE INVENTION

### Field of the Invention

The present invention relates to a regenerative fuel cell system and a method of operating the same.

### Description of the Related Art

In recent years, in order to make it possible for more people to be capable of relying thereon at an affordable cost, and to ensure access to sustainable and advanced energy, research and development have been conducted in relation to fuel cells that contribute to energy efficiency.

JP 7393450 B2 discloses a regenerative fuel cell system that uses a water electrolysis apparatus, a hydrogen pressurizing apparatus, and a fuel cell.

### SUMMARY OF THE INVENTION

In such a regenerative fuel cell system, if dew condensation occurs in a pipe through which hydrogen gas or oxygen gas flows, the dew condensation water adheres to a sensor or a device provided in the pipe, and the function of the sensor or the like may be impaired.

Therefore, in the regenerative fuel cell system, in order to remove the water in the pipe, warming and drying by a heater, and adsorption treatment of the water by a dehumidifier or an adsorbent are performed. However, there is a problem that electric energy is consumed in the warming and drying process by the heater and the dehumidifying process by the dehumidifier, and the adsorbent needs to be replaced when the adsorbent is used.

The present invention has the object of solving the aforementioned problems.

An aspect of the present disclosure is characterized by a regenerative fuel cell system including: a water electrolysis device configured to generate hydrogen gas and pressurized oxygen gas from water that is supplied, and cause the pressurized oxygen gas to be stored in an oxygen tank through an oxygen supply path; a hydrogen compression device configured to generate pressurized hydrogen gas from the hydrogen gas supplied from the water electrolysis device through a first hydrogen supply path and cause the pressurized hydrogen gas to be stored in a hydrogen tank through a second hydrogen supply path, and further configured to return hydrogen gas that has not been pressurized, to the first hydrogen supply path through a hydrogen discharge path; a fuel cell configured to perform power generation by an electrochemical reaction by the oxygen gas stored in the oxygen tank and the hydrogen gas stored in the hydrogen tank being supplied and to generate the water; a first external relief valve provided between the oxygen supply path communicating with the water electrolysis device and a vacuum space; a second external relief valve provided between the second hydrogen supply path communicating with the hydrogen compression device and the vacuum space; a third external relief valve provided between the hydrogen discharge path communicating with the hydrogen compression device and the vacuum space; and a fourth external relief valve provided between the first hydrogen supply path communicating with the hydrogen compression device and the vacuum space.

Another aspect of the present disclosure is characterized by a method of operating a regenerative fuel cell system, the method including: a gas accumulation step of, by a water electrolysis device, generating hydrogen gas and pressurized oxygen gas from water that is supplied and causing the pressurized oxygen gas to be stored in an oxygen tank through an oxygen supply path, and by a hydrogen compression device which is supplied with the hydrogen gas through a first hydrogen supply path, generating pressurized hydrogen gas and causing the pressurized hydrogen gas to be stored in a hydrogen tank through a second hydrogen supply path; a depressurizing step of, after the gas accumulation step, depressurizing an inside of the oxygen supply path and an inside of the second hydrogen supply path by power generation by a fuel cell which is supplied with the oxygen gas remaining in the oxygen supply path and the hydrogen gas remaining in the second hydrogen supply path; and a water removal step of, after the depressurizing step, causing the oxygen supply path, the first hydrogen supply path, a hydrogen discharge path for the hydrogen gas that has not been pressurized by the hydrogen compression device, and the second hydrogen supply path, to communicate with a vacuum space, and thereby vaporizing dew condensation water remaining in the oxygen supply path, the first hydrogen supply path, the hydrogen discharge path, and the second hydrogen supply path.

According to the present invention, the first to fourth external relief valves that can communicate with the vacuum space are provided respectively between the oxygen supply path communicating with the water electrolysis device and the vacuum space, between the second hydrogen supply path communicating with the hydrogen compression device and the vacuum space, between the hydrogen discharge path communicating with the hydrogen compression device and the vacuum space, and between the first hydrogen supply path communicating with the hydrogen compression device and the vacuum space. With this configuration, by opening the first to fourth external relief valves, the inside of the oxygen supply path, the inside of the second hydrogen supply path, the inside of the hydrogen discharge path, and the inside of the first hydrogen supply path can be caused to communicate with the vacuum space, thereby removing water.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic diagram showing a regenerative fuel cell system according to an embodiment;

FIG. 2 is a time chart for explaining operation of the regenerative fuel cell system;

FIG. 3 is an explanatory diagram of an oxygen depressurizing region and a hydrogen depressurizing region;

FIG. 4 is an explanatory diagram of an operation of converting oxygen and hydrogen, which have cross-leaked from a high pressure side to a low pressure side at a time of a depressurizing process, into water by an oxygen removal catalyst;

FIG. 5 is an explanatory diagram of a water removing region communicating with a vacuum space; and

FIG. 6 is a time chart for explaining operation of a regenerative fuel cell system according to a modification.

### DETAILED DESCRIPTION OF THE INVENTION

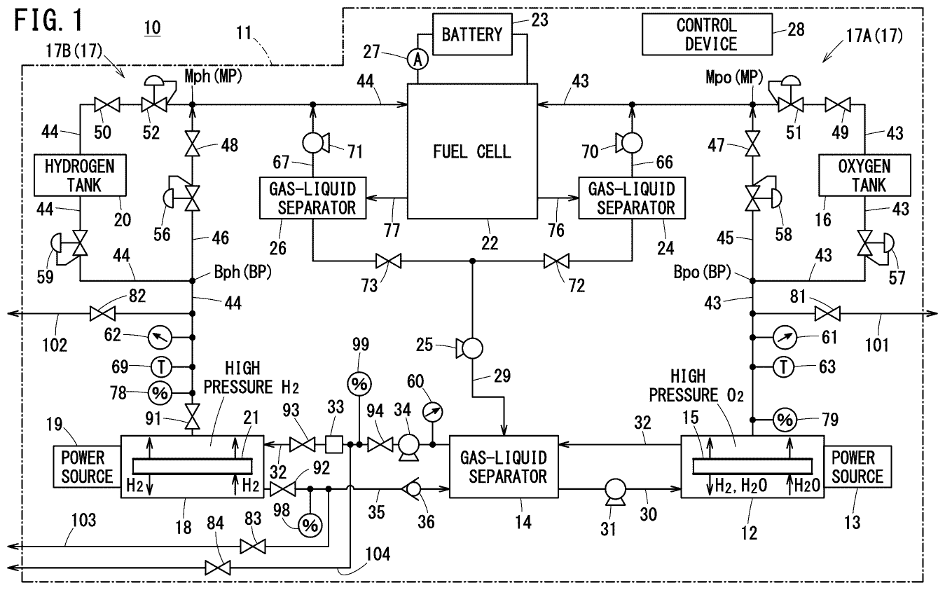

FIG. 1 is a schematic diagram showing a regenerative fuel cell system (regenerative fuel cell system: RFC) 10 according to an embodiment. The regenerative fuel cell system 10 may be used, for example, in a vacuum space, such as in outer space, or the lunar surface or the like. The regenerative fuel cell system 10 includes a casing 11. The casing 11 surrounds the entire interior of the regenerative fuel cell system 10. Thus, the casing 11 can form an airtight structure by isolating the interior of the regenerative fuel cell system 10 from the vacuum space.

### [Overall Description of Regenerative Fuel Cell System 10]

The regenerative fuel cell system 10 basically comprises a water electrolysis device 12, a gas-liquid separator (a hydrogen gas-liquid separator, a hydrogen gas supply device) 14, an oxygen tank 16, a hydrogen compression device 18, a hydrogen tank 20, a fuel cell 22, a battery 23, a gas-liquid separator (an oxygen exhaust gas gas-liquid separator) 24, a gas-liquid separator (a hydrogen exhaust gas gas-liquid separator) 26, and a control device 28. The control device 28 controls all of the constituent elements of the regenerative fuel cell system 10.

In the present embodiment, the water electrolysis device 12 is a high differential pressure water electrolysis stack apparatus (hereinafter abbreviated as EC) which serves to generate, by way of electrolysis of water, an electrochemically compressed high pressure oxygen gas, and an unpressurized hydrogen gas (a low pressure hydrogen gas). Water for water electrolysis is supplied from the gas-liquid separator 14 to the water electrolysis device 12 via a water supply path 30.

The water supply path 30 communicates with the water electrolysis device 12 and the gas-liquid separator 14. The water supply path 30 is provided with a pump 31. The pump 31 is ON/OFF controlled by the control device 28. When turned on, the pump 31 applies mechanical energy to water in the gas-liquid separator 14, and supplies the water from the gas-liquid separator 14 to the water electrolysis device 12. When the pump 31 is turned OFF, supply of the water is stopped. Similarly, all of the other pumps described below impart mechanical energy to a fluid when turned ON, and stop the flow of the fluid when turned OFF.

The water electrolysis device 12 includes one or more unit cells each having an electrolyte membrane 15. Each of the unit cells includes a membrane electrode assembly (MEA) in which the electrolyte membrane 15 is sandwiched and held between an anode and a cathode. The electrolyte membrane 15 used in the water electrolysis device 12 is an anion exchange membrane in this embodiment. It may be a proton exchange membrane.

The water electrolysis device 12 supplies water supplied from the gas-liquid separator 14 to the cathode of each of the unit cells. Each of the unit cells electrolyzes the water based on a voltage applied from an electrical power source (power source) 13 to the anode and the cathode. In this case, at the anode, the high pressure oxygen gas which is pressurized (for example, in a range of from 1 to 100 MPa) is generated, and at the cathode, the unpressurized hydrogen gas is generated. The reaction formula on the anode side of the water electrolysis device 12 is shown below.

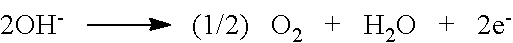

The reaction formula on the cathode side of the water electrolysis device 12 is shown below.

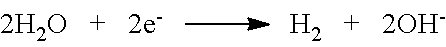

The control device 28 is capable of varying the voltage of the electrical power source 13 that is applied between the anode and the cathode. The electrical power of the electrical power source 13 may also utilize the electrical power of the battery 23.

The water electrolysis device 12 collects the high pressure oxygen gas generated in each of the unit cells, and outputs a released gas containing the collected oxygen gas through an oxygen supply path 43 to an oxygen supply mechanism 17A. Moreover, the released gas contains water vapor that is vaporized by the heat of the water electrolysis device 12 or the like.

At the same time, the water electrolysis device 12 collects the hydrogen gas generated in each of the unit cells, and surplus water (unreacted water) on which electrolysis has not been performed, and outputs a released fluid containing the collected hydrogen gas and unreacted water to a first hydrogen supply path 32. Moreover, the released fluid contains water vapor that is vaporized by the heat of the water electrolysis device 12 or the like.

The released fluid (the hydrogen gas and the unreacted water) that is output from the water electrolysis device 12 to the first hydrogen supply path 32 flows into the gas-liquid separator 14. The gas-liquid separator 14 separates the released fluid into a gas component (hydrogen gas and water vapor), and a liquid component (liquid water). The gas component is supplied to the hydrogen compression device 18 through the first hydrogen supply path 32 by turning ON a pump 34 of the first hydrogen supply path 32 that is provided on an outlet side of the gas-liquid separator 14. The hydrogen gas supplied to the hydrogen compression device 18 through the first hydrogen supply path 32 passes through the stored water in the gas-liquid separator 14 via a pipe (not shown) therein, and is supplied from the gas-liquid separator 14 to the first hydrogen supply path 32.

A pressure sensor 60 is provided on the first hydrogen supply path 32 near the outlet of the gas-liquid separator 14. Further, the pressure sensor 60, the pump 34, a shutoff valve 94, a fourth humidity sensor 99, an oxygen remover 33, and an inlet stop valve 93 are provided in this order from the outlet between the outlet of the gas-liquid separator 14 and the inlet of the hydrogen compression device 18. The fourth humidity sensor 99 may be a dew-point meter.

A fourth external discharge path 104 communicating with an external vacuum space is provided in a communication portion between the oxygen remover 33 and the shutoff valve 94, on the first hydrogen supply path 32. A fourth external relief valve 84 (external relief valve, on-off valve) is provided on the fourth external discharge path 104.

The oxygen remover 33 causes the oxygen gas discharged from the water electrolysis device 12 into the gas-liquid separator 14 at the time of the depressurizing process, and the hydrogen gas discharged from the hydrogen compression device 18 into the gas-liquid separator 14 through a hydrogen discharge path 35 at the time of the depressurizing process to react with each other by means of an oxygen removal catalyst to thereby produce water.

A second outlet stop valve 92, a third humidity sensor 98, and a check valve 36 are provided in this order from the outlet of the hydrogen discharge path 35 of the hydrogen compression device 18 toward the inlet side of the gas-liquid separator 14. The third humidity sensor 98 may be a dew-point meter.

A third external discharge path 103 communicating with an external vacuum space is provided in a communication portion between the second outlet stop valve 92 and the check valve 36, on the hydrogen discharge path 35. A third external relief valve 83 (external relief valve, on-off valve) is provided on the third external discharge path 103.

The hydrogen compression device 18 includes a membrane electrode assembly (MEA) in which an electrolyte membrane 21 is sandwiched and held between an anode and a cathode. The electrolyte membrane 21 used in the hydrogen compression device 18 is a proton exchange membrane. An electrical power source (power source) 19 is connected to the anode and the cathode.

The control device 28 is capable of varying the voltage of the electrical power source 19 that is applied between the anode and the cathode. The electrical power of the electrical power source 19 may also utilize the electrical power of the battery 23.

The hydrogen compression device 18 supplies the hydrogen gas flowing in from the first hydrogen supply path 32, to the anode. The hydrogen compression device 18 ionizes the hydrogen gas based on the voltage applied from the electrical power source 19. Protons, which are obtained by ionizing the hydrogen gas, together with water vapor, reach the cathode via the electrolyte membrane 21 (the proton exchange membrane). The protons that have reached the cathode combine with the electrons (the electrons generated at the time of the ionization) supplied from the electrical power source 19, and are returned to the hydrogen gas.

The hydrogen compression device 18, by transferring the protons from the anode to the cathode, generates a pressurized hydrogen gas. As an example, the hydrogen gas is compressed to be in a range of 1 MPa to 100 MPa. In this manner, the hydrogen compression device 18 is an electrochemical hydrogen compressor (EHC: Electrochemical Hydrogen Compressor) that electrochemically compresses the hydrogen gas. The reaction formula on the cathode side of the hydrogen compression device 18 is shown below.

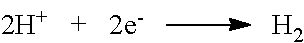

The reaction formula on the anode side of the hydrogen compression device 18 is shown below.

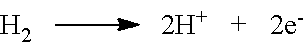

The hydrogen compression device 18 outputs surplus hydrogen gas that has not been ionized, to the hydrogen discharge path 35. The hydrogen discharge path 35 serves as a flow path (a pipe) in order to discharge the hydrogen gas from the hydrogen compression device 18 into the gas-liquid separator 14.

The hydrogen compression device 18 outputs a released gas containing the pressurized hydrogen gas to a hydrogen supply mechanism 17B. Moreover, the released gas contains water vapor that is vaporized by the heat of the hydrogen compression device 18 or the like.

The oxygen supply mechanism 17A and the hydrogen supply mechanism 17B constitute a gas supply mechanism 17. The gas supply mechanism 17 is a mechanism for supplying gases (hydrogen gas and oxygen gas) to the fuel cell 22.

The oxygen supply mechanism 17A supplies the oxygen gas generated in the water electrolysis device 12 to the fuel cell 22. The hydrogen supply mechanism 17B supplies the hydrogen gas generated in the hydrogen compression device 18 to the fuel cell 22.

Shutoff valves 47 to 50, a first external relief valve 81, a second external relief valve 82, the third external relief valve 83, the fourth external relief valve 84, a first outlet stop valve 91, the second outlet stop valve 92, the inlet stop valve 93, and the shutoff valve 94 are on-off valves. In this embodiment, as the on/off valve, a solenoid valve that opens (at the time of ON) and closes (at the time of OFF) under on/off drive control of the control device 28 is used.

### [Description of Oxygen Supply Mechanism 17A]

The oxygen supply mechanism 17A includes the oxygen supply path 43, the oxygen tank 16, a bypass path 45, the shutoff valve 47, the shutoff valve 49, a pressure reducing valve 51, a pressure reducing valve 58, a back pressure valve 57, a pressure sensor 61, a temperature sensor 63, and a first humidity sensor 79. The first humidity sensor 79 may be a dew-point meter.

The oxygen supply path 43 is a flow path in order to supply the high pressure oxygen gas generated in the water electrolysis device 12, via the oxygen tank 16, to the fuel cell 22. One end of the oxygen supply path 43 is connected to the water electrolysis device 12, and the other end of the oxygen supply path 43 is connected to the fuel cell 22.

The oxygen tank 16 is disposed on the oxygen supply path 43. The oxygen tank 16 stores therein the high pressure oxygen gas generated by the water electrolysis device 12

The bypass path 45 branches off from a branching portion Bpo (BP) of the oxygen supply path 43 between the water electrolysis device 12 and the oxygen tank 16, and merges with a merging portion Mpo (MP) of the oxygen supply path 43 between the oxygen tank 16 and the fuel cell 22.

The shutoff valve 47 is provided in the bypass path 45. The shutoff valve 49 is disposed in the oxygen supply path 43 between the merging portion Mpo and the oxygen tank 16.

The pressure reducing valve 51 is disposed in the oxygen supply path 43 between the merging portion Mpo and the oxygen tank 16. The pressure reducing valve 51 reduces to a predetermined pressure the pressure of the oxygen gas that is supplied from the oxygen tank 16.

The back pressure valve 57 is disposed in the oxygen supply path 43 between the branching portion Bpo and the oxygen tank 16. The back pressure valve 57 applies pressure (back pressure) to the water electrolysis device 12 through the oxygen tank 16. In accordance with this feature, the pressure of the oxygen gas that is generated at the anode of the electrolyte membrane 15 of each of the unit cells of the water electrolysis device 12 rises, and becomes higher in pressure than the pressure of the hydrogen gas that is generated at the cathode.

The water electrolysis device 12 generates at the anode the oxygen gas, the pressure of which is higher than that of the hydrogen gas that is generated at the cathode. Accordingly, cross-leaking, by which the hydrogen gas permeates through the electrolyte membrane 15 from the cathode toward the anode, can be suppressed. As a result, a reduction in the amount of the hydrogen gas supplied from the water electrolysis device 12 to the hydrogen compression device 18 can be prevented.

The pressure sensor 61 is provided in the oxygen supply path 43 between the water electrolysis device 12 and the branching portion Bpo. The pressure sensor 61 detects the pressure of the oxygen gas that is supplied from the water electrolysis device 12 to the oxygen supply path 43. The pressure sensor 61 outputs to the control device 28 a signal indicative of the detected pressure.

The temperature sensor 63 is provided in the oxygen supply path 43 between the water electrolysis device 12 and the branching portion Bpo. The temperature sensor 63 detects the temperature of the oxygen gas that is supplied from the water electrolysis device 12 to the oxygen supply path 43. The temperature sensor 63 outputs to the control device 28 a signal indicative of the detected temperature.

The first humidity sensor 79 is provided near the outlet of the water electrolysis device 12 for the pressurized oxygen gas. The first humidity sensor 79 detects the relative humidity of the oxygen supply path 43 (more specifically, the anode side of the electrolyte membrane 15 of the water electrolysis device 12). The first humidity sensor 79 outputs to the control device 28 a signal indicative of the detected humidity.

The pressurized oxygen gas discharged from the water electrolysis device 12 to the oxygen supply path 43 contains water vapor generated by the reaction at the anode, in addition to the oxygen gas.

A first external discharge path 101 communicating with an external vacuum space is provided on the oxygen supply path 43 communicating with the water electrolysis device 12. The first external relief valve 81 (external relief valve, on-off valve) is provided on the first external discharge path 101.

The gas-liquid separator 14 stores the water that is supplied to the water electrolysis device 12. The water supply path 30 is disposed between the gas-liquid separator 14 and the water electrolysis device 12. The pump 31 is disposed on the water supply path 30.

### [Description of Hydrogen Supply Mechanism 17B]

The hydrogen supply mechanism 17B includes a second hydrogen supply path 44, the hydrogen tank 20, a bypass path 46, the shutoff valve 48, the shutoff valve 50, the first outlet stop valve 91, a pressure reducing valve 52, a pressure reducing valve 56, a back pressure valve 59, a pressure sensor 62, a temperature sensor 69, and a second humidity sensor 78. The second humidity sensor 78 may be a dew-point meter.

The second hydrogen supply path 44 is a flow path in order to supply to the fuel cell 22, via the hydrogen tank 20, the hydrogen gas that has been pressurized by the hydrogen compression device 18. One end of the second hydrogen supply path 44 is connected to the hydrogen compression device 18, and the other end of the second hydrogen supply path 44 is connected to the fuel cell 22.

The hydrogen tank 20 is disposed on the second hydrogen supply path 44. The hydrogen tank 20 stores the high pressure hydrogen gas pressurized by the hydrogen compression device 18.

The bypass path 46 branches off from a branching portion Bph (BP) of the second hydrogen supply path 44 between the hydrogen compression device 18 and the hydrogen tank 20, and merges with a merging portion Mph (MP) of the second hydrogen supply path 44 between the hydrogen tank 20 and the fuel cell 22.

The on-off valve (shutoff valve) 48 is provided in the bypass path 46. The on-off valve (shutoff valve) 50 is disposed in the second hydrogen supply path 44 between the merging portion Mph and the hydrogen tank 20. The first outlet stop valve 91 is provided near the outlet of the hydrogen compression device 18 for the pressurized hydrogen gas.

The pressure reducing valve 52 is disposed in the second hydrogen supply path 44 between the merging portion Mph and the hydrogen tank 20. The pressure reducing valve 52 reduces to a predetermined pressure the pressure of the hydrogen gas that is supplied from the hydrogen tank 20.

The back pressure valve 59 is disposed in the second hydrogen supply path 44 between the branching portion Bph and the hydrogen tank 20. The back pressure valve 59 applies a pressure (a back pressure) to the hydrogen compression device 18. In accordance with this feature, the pressure of the hydrogen gas that is generated at the cathode of each of the unit cells of the hydrogen compression device 18 rises, and becomes higher in pressure than the pressure of the hydrogen gas that is supplied to the anode.

The hydrogen compression device 18 generates at the cathode the hydrogen gas having a pressure higher than that of the hydrogen gas that is supplied to the anode. Accordingly, cross-leaking, by which the hydrogen gas permeates through the electrolyte membrane 21 from the cathode toward the anode, can be suppressed.

The pressure sensor 62 is provided in the second hydrogen supply path 44 near the hydrogen compression device 18. The pressure sensor 62 detects the pressure of the pressurized hydrogen gas that is supplied to the second hydrogen supply path 44. The pressure sensor 62 outputs to the control device 28 a signal indicative of the detected pressure.

The temperature sensor 69 is provided near the branching portion Bph. The temperature sensor 69 detects the temperature of the hydrogen gas that is supplied from the hydrogen compression device 18 to the second hydrogen supply path 44. The temperature sensor 69 outputs to the control device 28 a signal indicative of the detected temperature.

The second humidity sensor 78 is provided in the second hydrogen supply path 44.

The second humidity sensor 78 detects the relative humidity of the second hydrogen supply path 44. More specifically, the second humidity sensor 78 detects the relative humidity of the cathode side of the electrolyte membrane 21 of the hydrogen compression device 18. The second humidity sensor 78 outputs to the control device 28 a signal indicative of the detected humidity.

A second external discharge path 102 communicating with an external vacuum space is provided on the second hydrogen supply path 44 near the branching portion Bph. The second external relief valve 82 is provided on the second external discharge path 102.

### [Description of Fuel Cell 22]

The oxygen supply mechanism 17A further includes an oxygen exhaust gas path 76, the gas-liquid separator 24, a circulation pump 70, and a drain valve 72.

The hydrogen supply mechanism 17B further includes a hydrogen exhaust gas path 77, the gas-liquid separator 26, a circulation pump 71, and a drain valve 73.

The fuel cell 22 includes a stack made up from a plurality of unit cells that are electrically connected in series. Each of the unit cells includes a membrane electrode assembly (MEA) in which an electrolyte membrane is sandwiched and held between an anode and a cathode.

The fuel cell 22 supplies the oxygen gas, which is supplied from the oxygen tank 16, via the pressure reducing valve 51, to the cathode of each of the unit cells. The fuel cell 22 supplies the hydrogen gas, which is supplied from the hydrogen tank 20, via the pressure reducing valve 52, to the anode of each of the unit cells. Each of the unit cells of the fuel cell 22 generates power by means of an electrochemical reaction between the oxygen gas and the hydrogen gas. The reaction formula on the anode side of the fuel cell 22 is shown below.

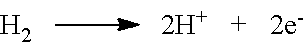

The reaction formula on the cathode side of the fuel cell 22 is shown below.

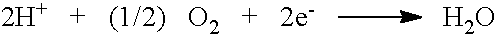

The power generated by the fuel cell 22 is supplied to a load (not shown) (a load such as an external actuator or an electric appliance) and is also supplied to an auxiliary load including the control device 28. A surplus portion of the generated power is charged into the battery 23. A power generation current Ifc of the fuel cell 22 is detected by an electrical current sensor 27, and is acquired by the control device 28. The stored voltage of the battery 23 and the generated voltage of the fuel cell 22 are detected by non-illustrated voltage sensors, and are acquired by the control device 28.

An oxygen-containing exhaust gas, which contains an unreacted oxygen gas in each of the unit cells of the fuel cell 22, is supplied, via an oxygen circulation path 66, to the oxygen supply path 43. The oxygen circulation path 66 is a flow path for returning the oxygen-containing exhaust gas, which is discharged from the fuel cell 22, to the oxygen supply path 43.

The gas-liquid separator 24 and the circulation pump 70 are disposed on the oxygen circulation path 66. The gas-liquid separator 24 separates the oxygen-containing exhaust gas, which is discharged from the fuel cell 22 into the oxygen exhaust gas path 76, into a gas component (oxygen gas and water vapor) and a liquid component (liquid water). The gas component is resupplied to the fuel cell 22 by the circulation pump 70. On the other hand, the liquid component is supplied to the gas-liquid separator 14 via the drain valve 72, which is an on-off valve, and a pump 25 which is provided on a water supply path 29 and which is turned on.

On the other hand, a hydrogen-containing exhaust gas, which contains an unreacted hydrogen gas in each of the unit cells of the fuel cell 22, is supplied, via a hydrogen circulation path 67, to the second hydrogen supply path 44. The hydrogen circulation path 67 is a flow path in order to return the hydrogen-containing exhaust gas, which is discharged from the fuel cell 22, to the second hydrogen supply path 44.

The gas-liquid separator 26 and the circulation pump 71 are disposed on the hydrogen circulation path 67. The gas-liquid separator 26 separates the hydrogen-containing exhaust gas, which is discharged from the fuel cell 22 into the hydrogen exhaust gas path 77, into a gas component (hydrogen gas and water vapor) and a liquid component (liquid water). The gas component is resupplied to the fuel cell 22 by the circulation pump 71.

On the other hand, the liquid component is supplied to the gas-liquid separator 14 via the drain valve 73, which is an on-off valve, and the pump 25 which is turned on.

The water generated in the fuel cell 22 is supplied to the gas-liquid separator 14 via the gas-liquid separator 24, the gas-liquid separator 26, the drain valve 72, the drain valve 73, and the pump 25 on the water supply path 29.

### [Description of Control Device 28]

The control device 28 controls all of the constituent elements of the regenerative fuel cell system 10, and executes the operation of the regenerative fuel cell system 10.

The control device 28 is a computer that controls the regenerative fuel cell system 10. The control device 28 includes one or more processors and a storage medium. The storage medium may be constituted by a volatile memory and a non-volatile memory. The processor may be a CPU, an MCU, or the like. As examples of the volatile memory, there may be cited a RAM or the like. As examples of the nonvolatile memory, there may be cited a ROM, a flash memory, or the like.

The control device 28 turns ON the electrical power source 13 of the water electrolysis device 12, and thereby applies a voltage to the anode and the cathode of each of the unit cells. In addition thereto, the control device 28 turns ON the pump 31, and thereby supplies the water from the gas-liquid separator 14 to the water electrolysis device 12.

In accordance with this feature, the water electrolysis device 12 enters into an operating state (a pressurizing state, a water electrolysis state), and performs electrolysis (water electrolysis) of water.

When the control device 28 stops applying the voltage from the electrical power source 13 to the unit cells and stops supplying the water to the water electrolysis device 12, the water electrolysis device 12 becomes placed in a non-operating state (i.e., to a stopped state through a depressurized state).

Further, the control device 28 turns ON the electrical power source 19 of the hydrogen compression device 18, and thereby applies a voltage to the anode and the cathode of each of the unit cells. In addition, the control device 28 turns on the pump 34 to supply hydrogen gas from the water electrolysis device 12 to the hydrogen compression device 18 via the first hydrogen supply path 32 and the gas-liquid separator 14.

In accordance with this feature, the hydrogen compression device 18 enters into an operating state (a pressurizing state), and thereby pressurizes the hydrogen gas. When the control device 28 stops applying the voltage from the electrical power source 19 to the unit cells and stops supplying the hydrogen gas to the hydrogen compression device 18, the hydrogen compression device 18 becomes placed in a non-operating state (i.e., to a stopped state through a depressurized state).

### [Description of Operation of Regenerative Fuel Cell System 10]

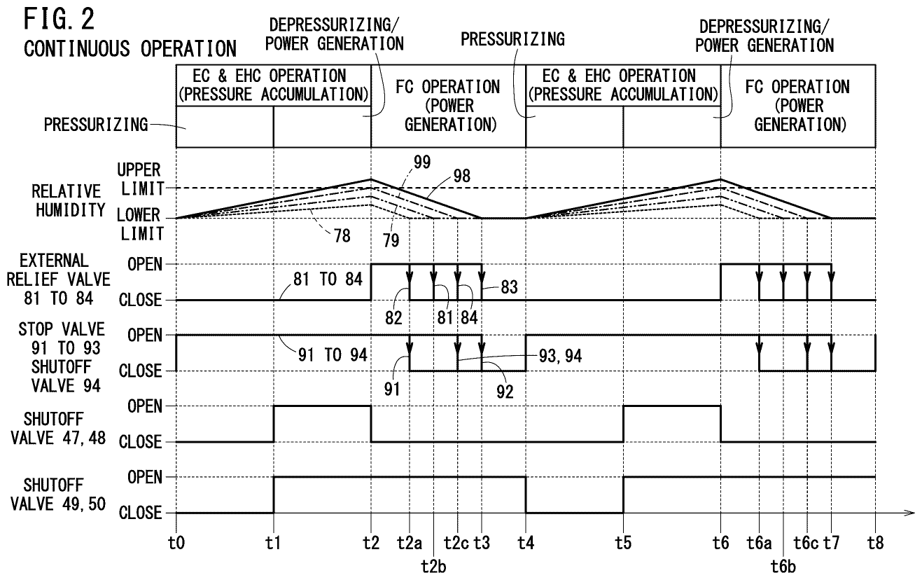

Basically, the operation of the regenerative fuel cell system 10 configured as described above during continuous operation will be described below with reference to the time chart of FIG. 2 (operation sequence during continuous operation).

In FIG. 2, EC represents the water electrolysis device 12, EHC represents the hydrogen compression device 18, and FC represents the fuel cell 22.

FIG. 2 schematically shows changes in relative humidity detected by the second humidity sensor 78, the fourth humidity sensor 99, the third humidity sensor 98, and the first humidity sensor 79 and acquired by the control device 28 by straight lines. The straight lines are denoted by the respective reference numerals 78, 99, 98 and 79 of the corresponding humidity sensors, which are represented respectively by a broken line, a one-dot chain line, a solid line and a two-dot chain line, along with the same types of lead lines. The relative humidity in the second hydrogen supply path 44 detected by the second humidity sensor 78 indicates the relative humidity of the cathode side of the electrolyte membrane 21 of the hydrogen compression device 18 when the first outlet stop valve 91 is open. The relative humidity in the first hydrogen supply path 32 is detected by the fourth humidity sensor 99. The relative humidity in the hydrogen discharge path 35 is detected by the third humidity sensor 98. The relative humidity in the oxygen supply path 43 of the water electrolysis device 12 detected by the first humidity sensor 79 indicates the relative humidity of the anode side of the electrolyte membrane 15.

In FIG. 2, the lower limit of the relative humidity indicates the lower limit humidity which should be met (i.e., should be followed) by the anode side of the electrolyte membrane 15 or the cathode side of the electrolyte membrane 21. In FIG. 2, the upper limit of the relative humidity indicates the upper limit humidity which should be met (i.e., should be followed) during the pressurizing operation of the water electrolysis device 12 and the hydrogen compression device 18. In the water electrolysis device 12 and the hydrogen compression device 18, the electrolyte membrane 15 and the electrolyte membrane 21 sufficiently fulfill their functions when being within the range between the upper limit and the lower limit during the pressurizing operation. As shown in FIG. 2, concerning the relative humidity during the pressurizing operation of the water electrolysis device 12 and the hydrogen compression device 18, the highest is the relative humidity acquired by the third humidity sensor 98 (hydrogen discharge path 35: high humidity), followed in order by the relative humidity acquired by the fourth humidity sensor 99 (first hydrogen supply path 32: medium humidity), the relative humidity acquired by the first humidity sensor 79 (oxygen supply path 43: high humidity), and the relative humidity acquired by the second humidity sensor 78 (second hydrogen supply path 44).

### [Pressurizing Step]

At the time t0, the water electrolysis device 12 starts the oxygen-pressurizing process. At a point in time immediately prior to time t0, the fuel cell 22, the water electrolysis device 12, and the hydrogen compression device 18 are stopped, and thus the regenerative fuel cell system 10 is stopped. In the state in which the regenerative fuel cell system 10 is stopped, the shutoff valves 47 to 50, each of which are shutoff valves in order to supply the oxygen gas and the hydrogen gas to the fuel cell 22, are closed. In a state where the regenerative fuel cell system 10 is stopped, the first external relief valve 81, the second external relief valve 82, the third external relief valve 83, the fourth external relief valve 84, the outlet stop valves 91 and 92, the inlet stop valve 93, and the shutoff valve 94 are closed.

At time t0, the operation of the regenerative fuel cell system 10 is started. In this case, the control device 28 first turns the outlet stop valves 91 and 92, the inlet stop valve 93, and the shutoff valve 94 from a closed state to an open state. Next, the control device 28 turns on the pump 31 to supply the water stored in the gas-liquid separator 14 to the cathode of the electrolyte membrane 15 of each unit cell of the water electrolysis device 12 through the water supply path 30.

The control device 28, next, supplies a predetermined electrical current from the electrical power source 13 to the cathode and the anode of each of the unit cells of the water electrolysis device 12, and thereby initiates the pressurizing operation of the water electrolysis device 12.

In this case, the oxygen gas which has been increased in pressure is generated by the electrolysis of water at the anodes. The oxygen gas is supplied, via the oxygen supply path 43 of the oxygen supply mechanism 17A, to the oxygen tank 16 of the oxygen supply mechanism 17A.

When the water electrolysis device 12 starts the pressurizing operation, hydrogen gas is generated by the electrolysis of water at the cathodes. The hydrogen gas is supplied from the water electrolysis device 12, via the pump 34 that has been turned ON and the first hydrogen supply path 32, to the anode of the electrolyte membrane 21 of each of the unit cells of the hydrogen compression device 18.

The control device 28 confirms the supply of the hydrogen gas to the first hydrogen supply path 32, based on the pressure detected by the pressure sensor 60.

When the supply of the hydrogen gas to the first hydrogen supply path 32 is confirmed, then, the control device 28 controls the electrical power source 19, and thereby causes the hydrogen compression device 18 to execute the pressurizing operation. When the hydrogen compression device 18 starts the pressurizing operation, the hydrogen gas pressurized by the hydrogen gas being ionized is generated at the cathode. This high pressure hydrogen gas is supplied to the hydrogen tank 20 via the second hydrogen supply path 44 of the hydrogen supply mechanism 17B.

At time t1, by means of the water electrolysis process and the hydrogen pressurizing process from time t0 to time t1, when a predetermined amount of the hydrogen and a predetermined amount of the oxygen are stored respectively in the hydrogen tank 20 and the oxygen tank 16, then the depressurizing (depressurizing/power generation) process by the control device 28 is started at time t1.

### [Depressurizing (Depressurizing/Power Generation) Step]

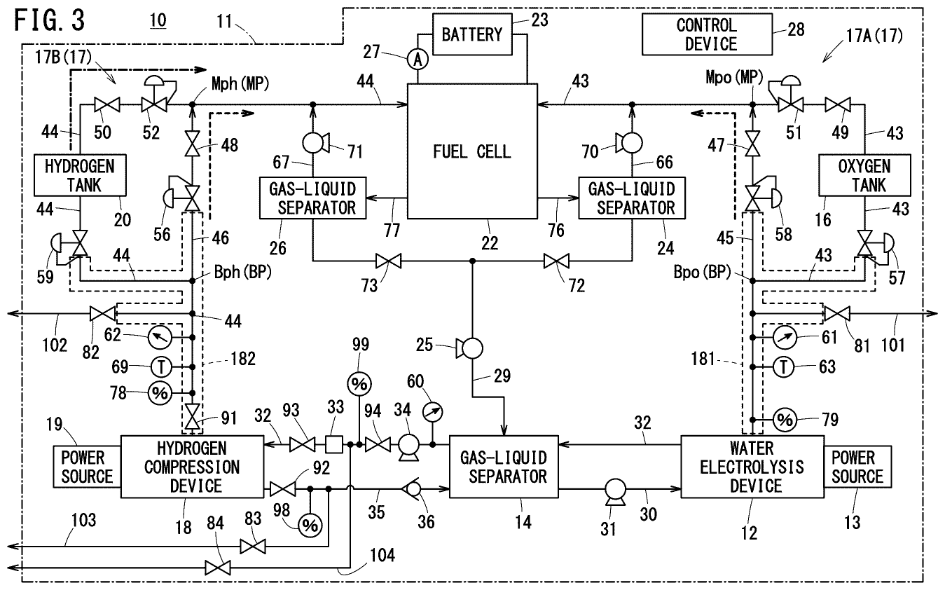

FIG. 3 is an explanatory diagram schematically showing the regions (an oxygen depressurizing region 181 and a hydrogen depressurizing region 182, which are surrounded respectively by dashed lines) to be subjected to the depressurizing process.

On the oxygen supply side, a region including a portion of the oxygen supply path 43 from the anode of the electrolyte membrane 15 of the water electrolysis device 12 up to a primary side of the back pressure valve 57 communicating with the anode of the water electrolysis device 12; a flow path portion from the anode of the water electrolysis device 12 up to a primary side of the pressure reducing valve 58; and a flow path portion from the anode of the water electrolysis device 12 up to the inlet side of the first external relief valve 81, correspond to the oxygen depressurizing region 181.

The oxygen depressurizing region 181 is a region where high-pressure oxygen gas remains when the water electrolysis device 12 stops the pressurizing operation.

On the other hand, on the hydrogen supply side, a portion of the second hydrogen supply path 44 that extends up to the primary side of the back pressure valve 59 communicating with the cathode of the hydrogen compression device 18; a region extending up to the primary side of the pressure reducing valve 56 communicating with the cathode of the hydrogen compression device 18; and a flow path portion extending up to the primary side of the second external relief valve 82 communicating with the cathode of the hydrogen compression device 18, correspond to the hydrogen depressurizing region 182. The hydrogen depressurizing region 182 is a region where high-pressure hydrogen gas remains when the pressurizing operation of the hydrogen compression device 18 is stopped.

During the period from the time t1 to the time t2, the control device 28 opens all the shutoff valves 47 to 50. In this case, for the oxygen depressurizing region 181, the control device 28 adjusts the pressure reducing valve 51 and the pressure reducing valve 58 in a manner so that a set pressure Psc of the pressure reducing valve 51 becomes lower than a set pressure Psd of the pressure reducing valve 58 (Psc<Psd).

Due to these settings, only the high pressure oxygen gas remaining in the oxygen depressurizing region 181 flows into the fuel cell 22 through the pressure reducing valve 58 and the bypass path 45, as shown by the thick dashed line in FIG. 3, and the oxygen gas does not flow through a portion of the oxygen supply path 43 in which the pressure reducing valve 51 is provided.

At the same time, for the hydrogen depressurizing region 182, the control device 28 adjusts the pressure reducing valve 52 and the pressure reducing valve 56 in a manner so that a set pressure Psa of the pressure reducing valve 52 becomes lower than a set pressure Psb of the pressure reducing valve 56 (Psa<Psb).

Due to these settings, only the high pressure hydrogen gas remaining in the hydrogen depressurizing region 182 flows into the fuel cell 22 through the pressure reducing valve 56 and the bypass path 46, as shown by the thick dashed line in FIG. 3, and the hydrogen does not flow through a portion of the second hydrogen supply path 44 in which the pressure reducing valve 52 is provided.

In this state, only the oxygen gas in the oxygen depressurizing region 181 which is a region for which the depressurization processing is required is supplied to the fuel cell 22 and only the hydrogen gas in the hydrogen depressurizing region 182 which is a region for which the depressurization processing is required is supplied to the fuel cell 22, and those supplied gases are consumed by the power generation by the electrochemical reaction of the fuel cell 22.

The control device 28 performs control such that the oxygen depressurizing region 181 and the hydrogen depressurizing region 182 are depressurized at respective predetermined depressurization rates during the depressurizing process.

The depressurization rate is a temporal change in each of the pressure values measured by the pressure sensor 61 and the pressure sensor 62. The control device 28 adjusts the set pressure of the pressure reducing valve 56 and the set pressure of the pressure reducing valve 58 to perform feedback control of the power generation current Ifc such that the temporal change in each of the pressure values becomes a predetermined value.

The control device 28 charges the battery 23 with the generated electrical power generated by the oxygen gas and the hydrogen gas that have been consumed in the fuel cell 22 during the depressurizing process.

When the depressurizing process is executed, the hydrogen in the hydrogen depressurizing region 182 is completely consumed earlier than the oxygen in the oxygen depressurizing region 181, due to the fact that 2 [mol] of the hydrogen are consumed with respect to every 1 [mol] of the oxygen by means of the electrochemical reaction in the fuel cell 22.

Thus, in that case, the control device 28 adjusts the set pressure Psa of the pressure reducing valve 52, in a manner so that the set pressure Psa of the pressure reducing valve 52 becomes the pressure measured by the pressure sensor 62 in the hydrogen depressurizing region 182.

Owing to this adjustment, as shown by the thick dashed-dotted line in FIG. 3, when the hydrogen inside the hydrogen depressurizing region 182 alone is not enough, hydrogen can be supplied from the hydrogen tank 20 to the fuel cell 22 so as to compensate for the deficiency of hydrogen. In this way, all of the high pressure oxygen gas in the oxygen depressurizing region 181 can be consumed.

During the depressurizing process described above, a pressure difference is generated across each electrolyte membrane 15 of the water electrolysis device 12 and across each electrolyte membrane 21 of the hydrogen compression device 18.

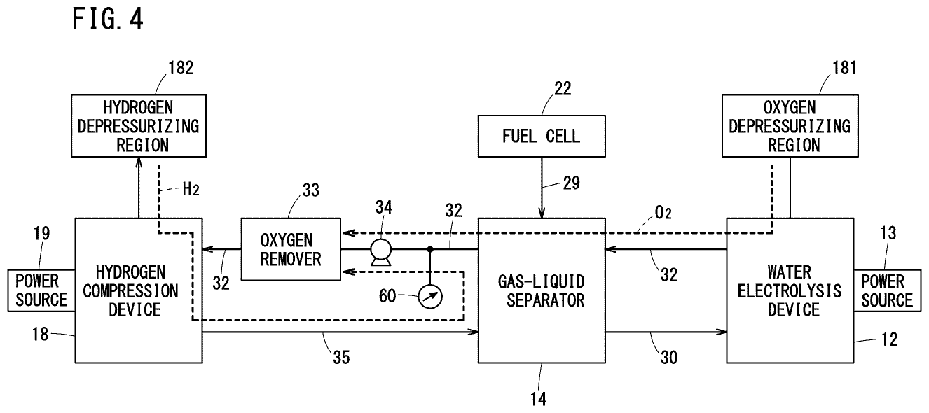

Therefore, as shown in FIG. 4, cross-leaking (cross-leaking of the oxygen permeating in the reverse direction through the electrolyte membrane 15 of the water electrolysis device 12, and cross-leaking of the hydrogen permeating in the reverse direction through the electrolyte membrane 21 of the hydrogen compression device 18), as shown by the thick dashed lines in FIG. 4, occurs from the high pressure side to the low pressure side of each of the stacks of the water electrolysis device 12 and the hydrogen compression device 18. The cross-leaked oxygen and the cross-leaked hydrogen must be subjected to the depressurizing process (disposal).

Concerning the cross-leaking of the oxygen in the water electrolysis device 12, as shown in FIG. 4, the hydrogen remaining in the gas-liquid separator 14 and the cross-leaked hydrogen supplied from the hydrogen compression device 18 through the hydrogen discharge path 35 to the gas-liquid separator 14, and the cross-leaked oxygen supplied from the water electrolysis device 12 through the first hydrogen supply path 32 to the gas-liquid separator 14, are made to react with each other in the oxygen remover 33 which is equipped with an oxygen removal catalyst, to thereby be converted into water, and thus the depressurizing is achieved.

For bringing about the reaction in the oxygen remover 33, the pump 34 is turned ON, and the oxygen and the hydrogen that have cross-leaked are made to flow through the first hydrogen supply path 32.

In general, concerning the cross-leaking of the oxygen and the cross-leaking of the hydrogen, the cross-leaking becomes greater for the hydrogen whose molecules are smaller. Therefore, the hydrogen remains on the primary side of the hydrogen compression device 18 which communicates with the hydrogen discharge path 35, and more specifically, the hydrogen remains in the gas-liquid separator 14, and the pressure on the anode side of the electrolyte membrane 21 rises.

Therefore, as for the remaining hydrogen gas, a current is supplied from the electrical power source 19 to the hydrogen compression device 18 during the depressurizing control, and the hydrogen gas remaining in the anode is increased in pressure and transferred to the cathode side. The high pressure hydrogen gas pressurized on the cathode side can be consumed by the above-described depressurizing process performed on the hydrogen depressurizing region 182. The depressurizing process is completed at time t2.

### [Water Removal Step in FC Operation (Power Generation) Step]

As described above, FIG. 2 is a time chart for explaining the operation of the water removal process of the regenerative fuel cell system 10 during continuous operation for repeating a sequence of operations in which the water electrolysis device 12 and the hydrogen compression device 18 are operated (pressure is accumulated in the oxygen tank 16 and the hydrogen tank 20) and then stopped, and thereafter, the fuel cell 22 is operated (power generation).

At the time t2 when the depressurizing process is completed, the control device 28 first closes the shutoff valve 47 and the shutoff valve 48 from the open state.

Next, the control device 28 opens the first external relief valve 81, the second external relief valve 82, the third external relief valve 83, and the fourth external relief valve 84 from the closed state, and causes the external discharge paths 101 to 104, which are the valve paths of the external relief valves 81 to 84, to communicate with the vacuum space, and starts a vacuuming process.

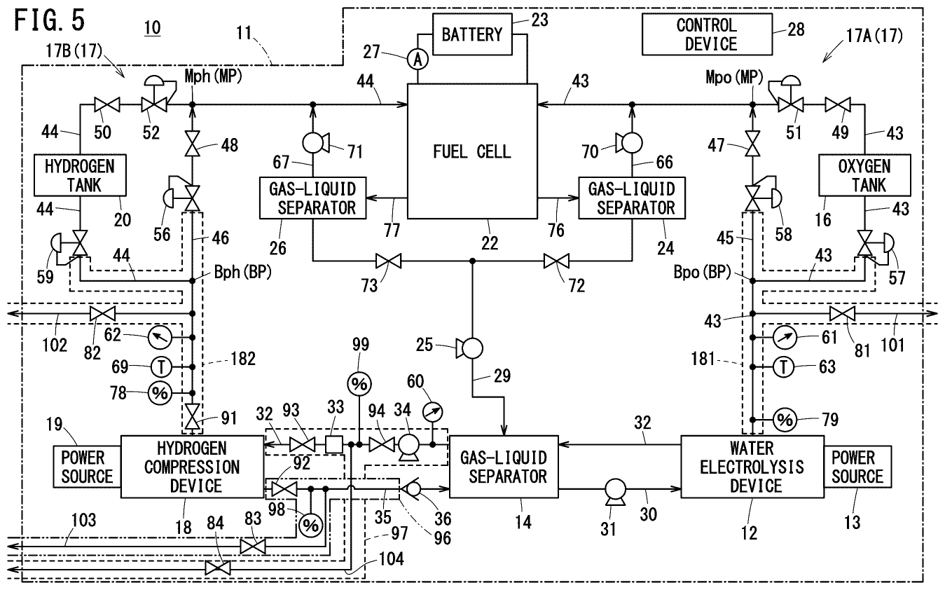

As shown in FIG. 5, on the hydrogen compression device 18 side, when the vacuuming process is started, the hydrogen depressurizing region 182, which is formed by portions of the second hydrogen supply path 44 and the bypass path 46 that communicate with the primary side of the pressure reducing valve 56, the primary side of the back pressure valve 59, and the cathode of the electrolyte membrane 21 of the hydrogen compression device 18, is caused to communicate with the vacuum space through the second external discharge path 102, by opening the second external relief valve 82. The water removal process for vaporizing the dew condensation water in the hydrogen depressurizing region 182 is started by the communication with the vacuum space (time t2 in FIG. 2).

At the same time, a partial region 96 of the hydrogen discharge path 35 communicating with the second outlet stop valve 92 and the check valve 36 which communicate with the outlet side of the anode of the hydrogen compression device 18 is caused to communicate with the vacuum space through the third external discharge path 103 by opening the third external relief valve 83, and then the water removal process for vaporizing the dew condensation water in the partial region 96 is started.

At the same time, a partial region 97 of the first hydrogen supply path 32 communicating with the inlet stop valve 93 and the shutoff valve 94 which communicate with the inlet side of the anode of the hydrogen compression device 18 is caused to communicate with the vacuum space through the fourth external discharge path 104 by opening the fourth external relief valve 84, and then the water removal process for vaporizing the dew condensation water in the partial region 97 is started.

On the other hand, on the water electrolysis device 12 side, the first external relief valve 81 is opened at the time t2, whereby the oxygen depressurizing region 181, which is formed by portions of the oxygen supply path 43 and the bypass path 45 that extend up to the primary side of the back pressure valve 57, the primary side of the pressure reducing valve 58, and the anode of the electrolyte membrane 15 of the water electrolysis device 12, communicates with the vacuum space. The water removal process for vaporizing the dew condensation water in the oxygen depressurizing region 181 is started by communicating with the vacuum space.

At the time t2a, the relative humidity detected by the second humidity sensor 78 reaches the lower limit, and the water removal process in the hydrogen depressurizing region 182 communicating with the cathode of the hydrogen compression device 18 is then terminated. At the time t2a, the second external relief valve 82 and the first outlet stop valve 91 are closed. At the time t2b, the relative humidity detected by the first humidity sensor 79 communicating with the anode of the water electrolysis device 12 reaches the lower limit, and the water removal process in the oxygen depressurizing region 181 is then terminated. At the time t2b, the first external relief valve 81 is closed. At the time t2c, the relative humidity detected by the fourth humidity sensor 99 reaches the lower limit, and the water removal process in the partial region 97 of the first hydrogen supply path 32 is then terminated. At the time t2c, the fourth external relief valve 84, the inlet stop valve 93, and the shutoff valve 94 are closed. At the point t3, the relative humidity detected by the third humidity sensor 98 communicating with the outlet side of the anode of the hydrogen compression device 18 via the second outlet stop valve 92 reaches the lower limit, and the water removal process in the partial region 96 is then terminated. At the time t3, the third external relief valve 83 and the second outlet stop valve 92 are closed. The above-described water removal process is terminated at the time when the relative humidity reaches the lower limit of the relative humidity (lower limit humidity). However, the external relief valves 81 to 84, the stop valves 91 to 93, and the shutoff valve 94 may be closed at the time when the relative humidity reaches a threshold (threshold humidity) higher than the lower limit, in order to leave a margin. On the other hand, the fuel cell 22 performs the power generation operation during the period from the time t2 to the time t4.

The processes of the time t5, the time t6, the times t6a to t6c, the time t7, and the time t8 in the period from the time t4 to the time t8, correspond respectively to the processes of the time t1, the time t2, the times t2a to t2c, the time t3, and the time t4 in the period from the time t0 to the time t4, and thus description thereof will be omitted.

As shown in FIG. 2, in a case where the pressure accumulation process on the oxygen tank 16 and the hydrogen tank 20 (time t0 to time t2, time t4 to time t6) and the power generation operation (time t2 to time t4, time t6 to time t8) are repeated, the water removal process (water removal step: time t2 to time t3, time t6 to time t7) are executed during the operation (power generation) of the fuel cell 22.

According to the embodiment, the following operation method of the regenerative fuel cell system 10 is performed.

The method of operating the regenerative fuel cell system 10 includes a gas accumulation step of generating hydrogen gas and pressurized oxygen gas from supplied water by the water electrolysis device 12 and causing the pressurized oxygen gas to be stored in the oxygen tank 16 through the oxygen supply path 43, and by the hydrogen compression device 18 which is supplied with the hydrogen gas through the first hydrogen supply path 32, generating pressurized hydrogen gas and causing the pressurized hydrogen gas to be stored in the hydrogen tank 20 through the second hydrogen supply path 44, a depressurizing step of, after the gas accumulation step, depressurizing the inside of the oxygen supply path 43 and the inside of the second hydrogen supply path 44 by power generation by the fuel cell 22 which is supplied with the oxygen gas remaining in the oxygen supply path 43 and the hydrogen gas remaining in the second hydrogen supply path 44, and a water removal step of, after the depressurizing step, causing the oxygen supply path 43, the first hydrogen supply path 32, the hydrogen discharge path 35 for the hydrogen gas that has not been pressurized by the hydrogen compression device 18, and the second hydrogen supply path 44 to communicate with the vacuum space, and thereby vaporizing the dew condensation water remaining in the oxygen supply path 43, the first hydrogen supply path 32, the hydrogen discharge path 35, and the second hydrogen supply path 44.

### Modifications

The above-described embodiment can be modified in the following manner.

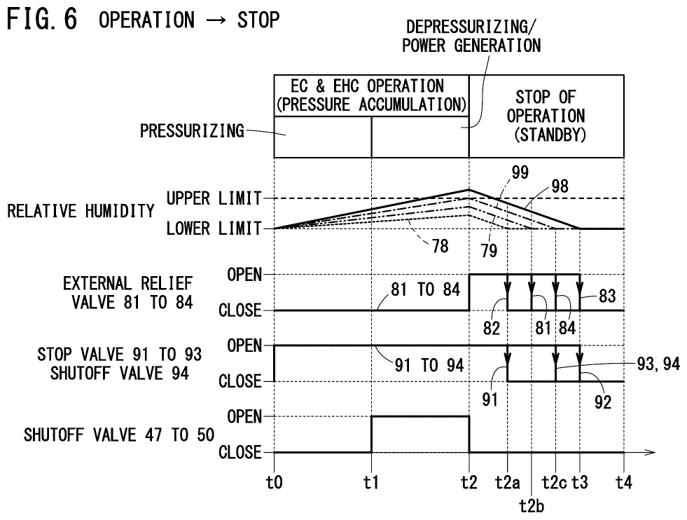

Description will be given with reference to a time chart, shown in FIG. 6, of a modification of a water removal process of the regenerative fuel cell system 10 (an operation sequence from start to stop of operation of the water electrolysis device 12 and the hydrogen compression device 18, which are compression devices).

Each operation from the time t0 to the time t4 in FIG. 6 corresponds to the operation from the time t0 to the time t4 in FIG. 2 described above, and thus will be briefly described.

In the water removal process shown in FIG. 6, instead of the water removal (time t2 to time t3) during the operation (FC operation (power generation)) of the fuel cell 22 from time t2 to time t4 shown in FIG. 2, the water removal process is performed during the stop of operation (standby) of the fuel cell 22 as shown between time t2 and time t3 in FIG. 6.

That is, after the pressurizing operation is performed by the water electrolysis device 12 and the hydrogen compression device 18 from the time t0 to the time t1 in FIG. 6, the depressurizing process is performed from the time t1 to the time t2, and the operations of the water electrolysis device 12 and the hydrogen compression device 18 are stopped at the time t2.

At time t2, the external relief valves 81 to 84 are opened to cause the oxygen supply path 43, the first hydrogen supply path 32, the second hydrogen supply path 44, and the hydrogen discharge path 35 of the regenerative fuel cell system 10 to communicate with the vacuum space, and water (dew condensation water) in the portions communicating with the vacuum space is removed by vaporization to a predetermined humidity, and the external relief valves 81 to 84 are then closed at the corresponding time t2a, time t2b, time t2c, and time t3.

In the hydrogen compression device 18, in order to prevent the inside including the electrolyte membrane 21 from drying, all the stop valves 91 to 93 are closed by the time t3, and thereafter, the closed state is maintained. In the water electrolysis device 12, the first external relief valve 81 is closed at the time t2b in order to prevent the inside including the electrolyte membrane 15 from drying.

### Effects of Embodiment and Modifications

In the above embodiment and the above modifications, when the water electrolysis device 12 and the hydrogen compression device 18 are stopped, the first external relief valve 81 provided between the vacuum space and the oxygen supply path 43 for supplying oxygen gas from the water electrolysis device 12 to the oxygen tank 16 and the fuel cell 22, the second external relief valve 82 provided between the vacuum space and the second hydrogen supply path 44 for supplying hydrogen gas from the hydrogen compression device 18 to the hydrogen tank 20 and the fuel cell 22, the third external relief valve 83 provided between the vacuum space and the hydrogen discharge path 35 for hydrogen gas not pressurized in the hydrogen compression device 18, and the fourth external relief valve 84 provided between the vacuum space and the first hydrogen supply path 32 for supplying hydrogen gas from the water electrolysis device 12 to the hydrogen compression device 18 are opened.

Thus, the oxygen supply path 43, the second hydrogen supply path 44, the hydrogen discharge path 35, and the first hydrogen supply path 32 communicate with the vacuum space, and water (dew condensation water) in the oxygen supply path 43, the second hydrogen supply path 44, the hydrogen discharge path 35, and the first hydrogen supply path 32 can be vaporized and removed by the vacuum state. After the removal, the first external relief valve 81, the second external relief valve 82, the third external relief valve 83, and the fourth external relief valve 84 are closed.

Therefore, even if the vacuum space outside the casing 11 of the regenerative fuel cell system 10 placed on the moon surface or the like becomes a freezing environment below the freezing point after water has been removed, the water inside the pipes in the oxygen supply path 43, the second hydrogen supply path 44, the hydrogen discharge path 35, and the first hydrogen supply path 32 of the regenerative fuel cell system 10 can be prevented from freezing.

According to the embodiment and the modifications, the first external relief valve 81, the second external relief valve 82, the third external relief valve 83, and the fourth external relief valve 84 are provided at portions where: freezing is likely to occur after the water electrolysis device 12 and the hydrogen compression device 18 have been stopped; and removal of water (dew condensation water) is therefore required. These valves allow such portions to communicate with the vacuum space through the valves, thereby vaporizing the water (dew condensation water). Therefore, the heater, the dehumidifier, and the adsorbent described in the background art are not required.

Concerning the above-described embodiment and modifications, the following Supplementary Notes are further disclosed. For convenience of understanding, reference numerals, which are written in parentheses, are attached as examples to the first appearing components.

### Supplementary Note 1

The regenerative fuel cell system (10) according to the present disclosure includes: the water electrolysis device (12) configured to generate hydrogen gas and pressurized oxygen gas from water that is supplied, and cause the pressurized oxygen gas to be stored in the oxygen tank (16) through the oxygen supply path (43); the hydrogen compression device (18) configured to generate pressurized hydrogen gas from the hydrogen gas supplied from the water electrolysis device through the first hydrogen supply path (32) and cause the pressurized hydrogen gas to be stored in the hydrogen tank (20) through the second hydrogen supply path (44), and further configured to return hydrogen gas that has not been pressurized, to the first hydrogen supply path through the hydrogen discharge path (35); the fuel cell (22) configured to perform power generation by an electrochemical reaction by the oxygen gas stored in the oxygen tank and the hydrogen gas stored in the hydrogen tank being supplied and to generate the water. The regenerative fuel cell system further includes: the first external relief valve (81) provided between the oxygen supply path communicating with the water electrolysis device and the vacuum space; the second external relief valve (82) provided between the second hydrogen supply path communicating with the hydrogen compression device and the vacuum space; the third external relief valve (83) provided between the hydrogen discharge path communicating with the hydrogen compression device and the vacuum space; and the fourth external relief valve (84) provided between the first hydrogen supply path communicating with the hydrogen compression device and the vacuum space.

### Supplementary Note 2

In the regenerative fuel cell system according to Supplementary Note 1, the first to fourth external relief valves may be closed when the water electrolysis device and the hydrogen compression device are in operation, and when operation of the water electrolysis device and the hydrogen compression device is stopped, the first to fourth external relief valves may be opened to thereby release water remaining in the oxygen supply path, the second hydrogen supply path, the hydrogen discharge path, and the first hydrogen supply path, to the vacuum space.

### Supplementary Note 3

In the regenerative fuel cell system according to Supplementary Note 2, before the first to fourth external relief valves are opened when the operation of the water electrolysis device and the hydrogen compression device is stopped, the fuel cell may be caused to perform power generation by the oxygen gas remaining in the oxygen supply path and the hydrogen gas remaining in the second hydrogen supply path, to thereby depressurize the oxygen supply path and the second hydrogen supply path.

### Supplementary Note 4

The regenerative fuel cell system according to Supplementary Note 3 may further include the shutoff valve (94) provided on the water electrolysis device side in the first hydrogen supply path; the inlet stop valve (93) provided on the hydrogen compression device side in the first hydrogen supply path; the first outlet stop valve (91) provided between the outlet for the hydrogen gas pressurized by the hydrogen compression device and the second hydrogen supply path; and the second outlet stop valve (92) provided in the hydrogen discharge path, and the shutoff valve, the inlet stop valve, the first outlet stop valve, and the second outlet stop valve may be opened during the operation and may be closed after the depressurizing.

### Supplementary Note 5

In the regenerative fuel cell system according to Supplementary Note 4, in the case of setting when to close the shutoff valve, the inlet stop valve, the first outlet stop valve, and the second outlet stop valve, the regenerative fuel cell system may further include the first humidity sensor (79) provided in the oxygen supply path communicating with the water electrolysis device; the second humidity sensor (78) provided in the second hydrogen supply path communicating with the hydrogen compression device; the third humidity sensor (98) provided in the hydrogen discharge path communicating with the hydrogen compression device; and the fourth humidity sensor (99) provided in the first hydrogen supply path communicating with the hydrogen compression device, and when a relative humidity detected by each of the first to fourth humidity sensors decreases to a lower limit humidity or a threshold humidity, the corresponding one of the shutoff valve, the inlet stop valve, the first outlet stop valve, and the second outlet stop valve may be closed, and the corresponding one of the first to fourth external relief valves may be closed.

### Supplementary Note 6

The method of operating the regenerative fuel cell system according to the present disclosure includes: the gas accumulation step of, by the water electrolysis device, generating hydrogen gas and pressurized oxygen gas from water that is supplied and causing the pressurized oxygen gas to be stored in the oxygen tank through the oxygen supply path, and by the hydrogen compression device which is supplied with the hydrogen gas through the first hydrogen supply path, generating pressurized hydrogen gas and causing the pressurized hydrogen gas to be stored in the hydrogen tank through the second hydrogen supply path; the depressurizing step of, after the gas accumulation step, depressurizing the inside of the oxygen supply path and the inside of the second hydrogen supply path by power generation by the fuel cell which is supplied with the oxygen gas remaining in the oxygen supply path and the hydrogen gas remaining in the second hydrogen supply path; and the water removal step of, after the depressurizing step, causing the oxygen supply path, the first hydrogen supply path, the hydrogen discharge path for the hydrogen gas that has not been pressurized by the hydrogen compression device, and the second hydrogen supply path, to communicate with the vacuum space, and thereby vaporizing the dew condensation water remaining in the oxygen supply path, the first hydrogen supply path, the hydrogen discharge path, and the second hydrogen supply path.

Although the present disclosure has been described in detail, the present disclosure is not limited to the above-described embodiment and modifications. These embodiments can be subjected to various additions, substitutions, modifications, partial deletions and the like, within a range that does not depart from the essence and gist of the present disclosure, or alternatively, the essence and gist of the present disclosure as derived from the contents described in the claims and their equivalents. These embodiments may also be implemented in combination. For example, in the above-described embodiments, the order of operations and the order of processes are shown as examples, and the present invention is not limited to them. The same applies also in the case that numerical values or mathematical equations are used in the description of the aforementioned embodiments.

1. A regenerative fuel cell system comprising:
a water electrolysis device configured to generate hydrogen gas and pressurized oxygen gas from water that is supplied, and cause the pressurized oxygen gas to be stored in an oxygen tank through an oxygen supply path;
a hydrogen compression device configured to generate pressurized hydrogen gas from the hydrogen gas supplied from the water electrolysis device through a first hydrogen supply path and cause the pressurized hydrogen gas to be stored in a hydrogen tank through a second hydrogen supply path, and further configured to return hydrogen gas that has not been pressurized, to the first hydrogen supply path through a hydrogen discharge path;
a fuel cell configured to perform power generation by an electrochemical reaction by the oxygen gas stored in the oxygen tank and the hydrogen gas stored in the hydrogen tank being supplied and to generate the water; and
external relief valves, wherein the external relief valves include:
a first external relief valve provided between the oxygen supply path communicating with the water electrolysis device and a vacuum space;
a second external relief valve provided between the second hydrogen supply path communicating with the hydrogen compression device and the vacuum space;
a third external relief valve provided between the hydrogen discharge path communicating with the hydrogen compression device and the vacuum space; and
a fourth external relief valve provided between the first hydrogen supply path communicating with the hydrogen compression device and the vacuum space.

2. The regenerative fuel cell system according to claim 1, wherein
the external relief valves are closed when the water electrolysis device and the hydrogen compression device are in operation, and when operation of the water electrolysis device and the hydrogen compression device is stopped, the external relief valves are opened to thereby release water remaining in the oxygen supply path, the second hydrogen supply path, the hydrogen discharge path, and the first hydrogen supply path, to the vacuum space.

3. The regenerative fuel cell system according to claim 2, wherein
before the external relief valves are opened when the operation of the water electrolysis device and the hydrogen compression device is stopped, the fuel cell is caused to perform power generation by the oxygen gas remaining in the oxygen supply path and the hydrogen gas remaining in the second hydrogen supply path, to thereby depressurize the oxygen supply path and the second hydrogen supply path.

4. The regenerative fuel cell system according to claim 3, further comprising:
a shutoff valve provided on a side of the water electrolysis device in the first hydrogen supply path;
an inlet stop valve provided on a side of the hydrogen compression device in the first hydrogen supply path;
a first outlet stop valve provided between an outlet for the hydrogen gas pressurized by the hydrogen compression device and the second hydrogen supply path; and
a second outlet stop valve provided in the hydrogen discharge path,
wherein the shutoff valve, the inlet stop valve, the first outlet stop valve, and the second outlet stop valve are opened during the operation of the water electrolysis device and the hydrogen compression device and are closed after depressurizing of the oxygen supply path and the second hydrogen supply path.

5. The regenerative fuel cell system according to claim 4, wherein
in a case of setting when to close the shutoff valve, the inlet stop valve, the first outlet stop valve, and the second outlet stop valve,
the regenerative fuel cell system further comprises humidity sensors, wherein the humidity sensors include:
a first humidity sensor provided in the oxygen supply path communicating with the water electrolysis device;
a second humidity sensor provided in the second hydrogen supply path communicating with the hydrogen compression device;
a third humidity sensor provided in the hydrogen discharge path communicating with the hydrogen compression device; and
a fourth humidity sensor provided in the first hydrogen supply path communicating with the hydrogen compression device, and
when a relative humidity detected by each of the humidity sensors decreases to a lower limit humidity or a threshold humidity, a corresponding one of the shutoff valve, the inlet stop valve, the first outlet stop valve, and the second outlet stop valve is closed, and a corresponding one of the external relief valves is closed.

6. A method of operating a regenerative fuel cell system, the method comprising:
by a water electrolysis device, generating hydrogen gas and pressurized oxygen gas from water that is supplied and causing the pressurized oxygen gas to be stored in an oxygen tank through an oxygen supply path, and by a hydrogen compression device which is supplied with the hydrogen gas through a first hydrogen supply path, generating pressurized hydrogen gas and causing the pressurized hydrogen gas to be stored in a hydrogen tank through a second hydrogen supply path;
after the pressurized oxygen gas and the pressurized hydrogen gas have been stored respectively in the oxygen tank and the hydrogen tank, depressurizing an inside of the oxygen supply path and an inside of the second hydrogen supply path by power generation by a fuel cell which is supplied with the oxygen gas remaining in the oxygen supply path and the hydrogen gas remaining in the second hydrogen supply path; and
after the depressurizing of the inside of the oxygen supply path and the inside of the second hydrogen supply path, causing the oxygen supply path, the first hydrogen supply path, a hydrogen discharge path for the hydrogen gas that has not been pressurized by the hydrogen compression device, and the second hydrogen supply path, to communicate with a vacuum space, and thereby vaporizing dew condensation water remaining in the oxygen supply path, the first hydrogen supply path, the hydrogen discharge path, and the second hydrogen supply path.
